(19) United States
(12) Patent Application Publication
(10) Pub. No.: US 2021/0312919 A1
(43) Pub. Date: Oct. 7, 2021

(54) CONVERSATION DEVICE

(71) Applicant: NTT DOCOMO, INC., Chiyoda-ku (JP)

(72) Inventors: Miyu SATO, Chiyoda-ku (JP); Kanako OONISHI, Chiyoda-ku (JP)

(73) Assignee: NTT DOCOMO, INC., Chiyoda-ku (JP)

(21) Appl. No.: 17/271,476

(22) PCT Filed: Aug. 29, 2019
(86) PCT No.: PCT/JP2019/033970

§ 371 Date: Feb. 25, 2021

(30) Foreign Application Priority Data
Sep. 13, 2018 (JP) 2018-171815

(51) Int. Cl. G10L 15/22; G10L 15/02; G06F 16/28

(52) U.S. Cl. CPC G10L 15/22; G06F 16/288; G10L 15/02

(57) ABSTRACT

Provided is a speech device capable of improving the quality of speech content at low cost. An extraction unit 102 analyzes user's speech content received by a conversation unit 101, and extracts topic information being a principal word from the speech content. In the above-described embodiment, the extraction unit 102 extracts the node information: “Shunsuke Nakamura.” A search unit 103 searches a graph database 105 by using node information being topic information as a key, and acquires corresponding node information and edge information. A conversation information generation unit 104 generates conversation information being response content by using the acquired node information and edge information. The conversation unit 101 outputs the generated conversation information to a user terminal 200.

### TECHNICAL FIELD

The present invention relates to a conversation device that makes a conversation with a user.

### BACKGROUND ART

Patent Literature 1 (Japanese Unexamined Patent Publication No. 2017-222402) describes a candidate speech generation device capable of making an appropriate response to a user's speech in a conversation system. This candidate speech generation device generates candidate speeches based on search results from a speech database using, as a search query, a word extracted by morphological analysis of a user's speech and the act of conversation.

### CITATION LIST

### Patent Literature

PTL1: Japanese Unexamined Patent Publication No. 2017-222402

### SUMMARY OF INVENTION

### Technical Problem

However, since the speech database described in Patent Literature 1 contains information obtained by crawling specified sites such as SNS (Social Network System), there is a possibility that the quality of speech content is low. Although an administrator can generate speech content in order to improve the speech content, it requires considerable cost.

In order to solve the above problem, an object of the present invention is to provide a speech device capable of improving the quality of speech content at low cost.

### Solution to Problem

According to the present invention, a storage unit configured to structurally store a plurality of registered words by using relationship information indicating a mutual relationship, an analysis unit configured to analyze speech content of a user, an extraction unit configured to extract a primary word from the speech content, a search unit configured to search the storage unit by using the primary word as a key, and acquire a corresponding registered word and relationship information as a response word and response relationship information, and a response unit configured to generate and output response content by using the response word and the response relationship information are included.

According to the present invention, response content for making a conversation with a user is generated with use of a storage unit that structurally stores a plurality of registered words by using relationship information indicating a mutual relationship. The quality of conversation content is thereby improved at low cost.

### Advantageous Effects of Invention

According to the present invention, the quality of conversation content is improved at low cost.

### BRIEF DESCRIPTION OF DRAWINGS

FIG. 1 is a block diagram showing the functional configuration of a conversation device according to one embodiment of the present disclosure.

FIG. 2 is a schematic diagram schematically showing a graph database.

FIG. 3 is a schematic diagram showing edge information containing time information and node information.

FIG. 4 is a view showing a specific example of a template database 106.

FIG. 5 is a flowchart showing the processing operation of the conversation device.

FIG. 6 is a schematic diagram of a graph database 105 where edge information contains a similarity score.

FIG. 7 is a schematic diagram showing the outline of processing for selecting common node information.

FIG. 8 is a schematic diagram showing a part of the graph database 105.

FIG. 9 is a flowchart showing the operation of a conversation device 100 capable of generating a supplementary sentence.

FIG. 10 shows a specific example of a property list table.

FIG. 11 is a view showing an example of the hardware configuration of the conversation device 100 according to one embodiment of the present disclosure.

### DESCRIPTION OF EMBODIMENTS

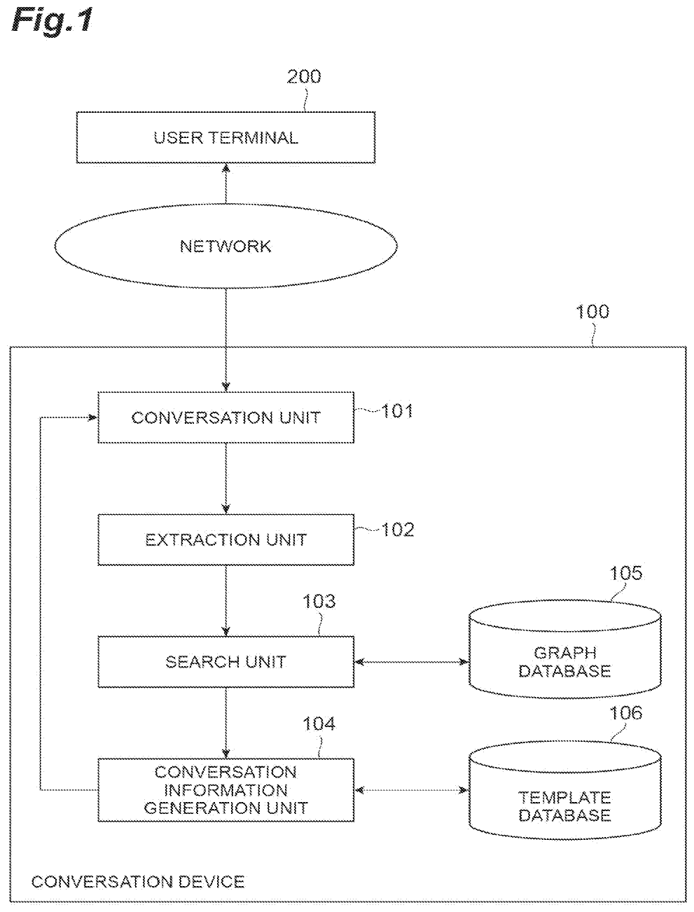

Embodiments of the present invention are described hereinafter with reference to the attached drawings. Note that, where possible, the same elements are denoted by the same reference symbols and redundant description thereof is omitted.

[Embodiment] FIG. 1 is a block diagram showing the functional configuration of a conversation device 100 according to one embodiment of the present disclosure. As shown in FIG. 1, the conversation device 100 receives speech information from a user terminal 200 and transmits conversation information in response to this conversation information, and thereby a user of the user terminal 200 can enjoy a conversation.

As shown in FIG. 1, this conversation device 100 includes a conversation unit 101 (response unit), an extraction unit 102 (analysis unit, extraction unit), a search unit 103 (search unit), a conversation information generation unit 104 (response unit), a graph database 105 (storage unit), and a template database 106.

The conversation unit 101 is a part that receives text information, which is speech information transmitted from the user terminal 200, and transmits text information, which is conversation information to be provided to the user terminal 200. Although the conversation unit 101 transmits and receives information to and from the user terminal 200 via a network in FIG. 1, it is not limited thereto, and it may make a direct conversation. In this case, a conversation by voice or a conversation by input/output of text information is made.

The extraction unit 102 is a part that analyzes the text information transmitted from the user terminal 200 and extracts focus information (topic information), which is the subject of the speech information. The focus information is information that is extracted on the basis of a feature vector (semantic vector) in a word and characters before and after the word, which is obtained by morphological analysis of the text information, and it is represented by a word or text. Extraction of the focus information is a known technique. The focus information is hereinafter referred to as topic information.

The search unit 103 is a part that searches the graph database 105 by using the topic information as a key, and thereby acquires edge information and node information derived from the topic information. Note that the search unit 103 selects and acquires one edge information and one node information according to specified conditions among the plurality of retrieved edge information and node information. For example, the search unit 10 randomly selects one edge information and one node information corresponding to this one edge information.

Further, in order generate a plurality of sentences according to the settings of the conversation device 100, after generating conversation information of the first sentence, the search unit 103 may change the topic information and repeat a search for other node information or the like. For example, the search unit 103 searches the graph database 105 by using the node information used for the generation of the conversation information of the first sentence as the topic information, and acquires the edge information and the node information derived from this topic information.

The conversation information generation unit 104 is a part that generates conversation information on the basis of the acquired edge information and node information. The detailed description is s follows.

The conversation information generation unit 104 acquires a template corresponding to the acquired edge information by referencing the template database 106. For example, when the edge information indicates “team”, it acquires a template for inserting the team name indicated by the node information associated by the edge information. In the template database 106, a template is prepared for each edge information. Further, a template of the past version (a template in the past tense) and a template of the present version (a template in the present tense) are prepared in some cases. Note that a template is a fixed format of a sentence, and it is data to form a sentence by pasting the node information and the topic information corresponding to the edge information.

The conversation information generation unit 104 determines whether the state indicated by the node information associated by the edge information or the relationship with the focus information is ongoing or not on the basis of time information accompanying the edge information. Then, the conversation information generation unit 104 acquires a template of the past version or the present version depending on whether it is ongoing or not. The graph database 105 that contains the edge information accompanied by the time information is described later.

The conversation information generation unit 104 inserts the node information based on the edge information and the topic information into specified positions in the acquired template and thereby generates conversation information.

Note that, when the number of edge information heading to the node information being the topic information is equal to or more than a predetermined number (e.g., 30 or more) in the graph database 105, the conversation information generation unit 104 may determine that a supplemental sentence is needed for this topic information and perform a supplemental sentence generation process. The supplemental sentence generation process is described later.

The conversation information generation unit 104 generates conversation information by using the edge information and the node information. This is repeated the specified number of times, and thereby conversation information of a plurality of sentences are generated. Note that a conjunction for joining conversation information may be inserted as appropriate.

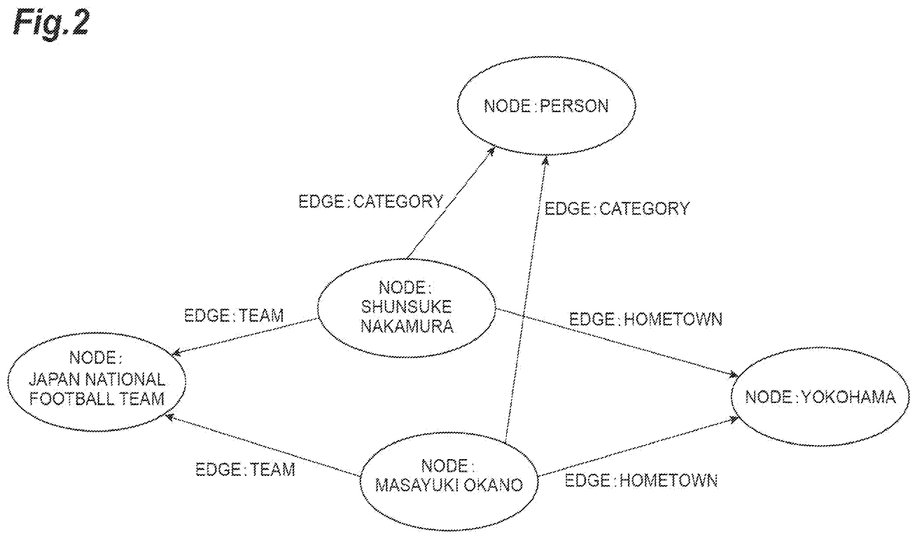

The graph database 105 is a database that structurally stores node information and edge information for generating conversation information in association with each other. FIG. 2 is a view schematically showing a specific example of the graph database 105. The graph database 105 structurally describes a plurality of registered words by using relationship information indicating a mutual relationship, and it describes information indicating a connection between a word and a word. As shown in FIG. 2, a word is treated as the node information, and a connection between the node information is indicated by the edge information. For example, other node information: Yokohama derives from the node information: Shunsuke Nakamura by using the edge information: hometown. This indicates that the node information: Yokohama is associated as a hometown of Shunsuke Nakamura. In other words, the node information: Shunsuke Nakamura and the node information: Yokohama are associated by the edge information: hometown. The deriving direction of the node information is indicated by the arrow in FIG. 2. The node information that derives from certain node information is information that describes this certain node information, and therefore the deriving direction is defined.

Note that other node information may be further associated from the node information: Yokohama by using other edge information. By repeatedly associating node information with other node information by using edge information, knowledge data using node information is structured in the graph database 105.

Although the graph database 105 may be generated manually by a database operator, it is generated from an information site or a dictionary site on the Internet according to a known graph database generation algorithm.

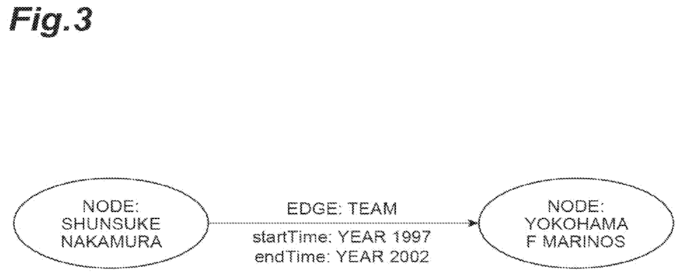

FIG. 3 is a schematic diagram showing edge information containing time information and node information. As shown in FIG. 3, the edge information: team contains start time and end time. This indicates a period of time during which the node information: Shunsuke Nakamura had belonged to the node information: Yokohama F Marinos as the edge information: team. When the end time is not shown, it can be determined to be ongoing. Further, when the start time and the end time are not contained, it can be regarded as the edge information without the concept of present and past. In this case, it is treated like being ongoing. For example, when the edge information is a hometown, the edge information: hometown is not information with a temporal end. Such edge information does not need to contain the start time and the end time. Alternatively, such edge information may only contain the start time. Note that information indicating whether it is ongoing is not limited to the start time or the like, and information indicating “ongoing” may be simply contained in the edge information.

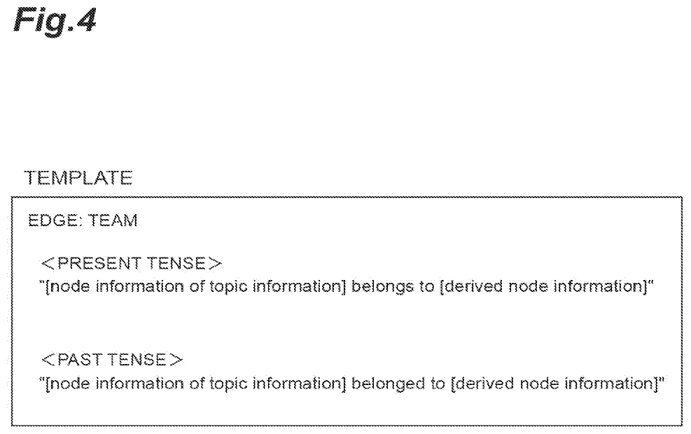

FIG. 4 is a view showing a specific example of the template database 106. As shown in FIG. 4 a template is described in each of the present tense and the past tense. Further, there is blank space to insert certain node information of topic information and node information that derives from this certain node information. Further, the template database 106 stores a template corresponding to edge information. FIG. 4 shows the template for the edge information: team. This template is configured so that node information corresponding to topic information and node information that drives by the edge information: team are inserted to its blank space.

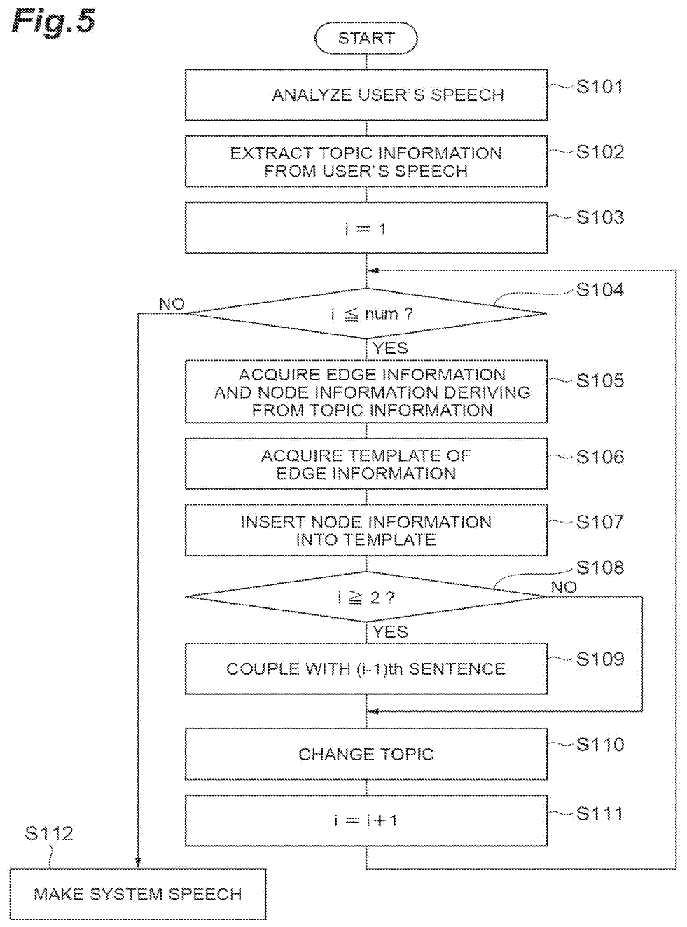

The operation of the conversation device 100 configured as above is described hereinafter. FIG. 5 is a flowchart showing the operation of the conversation device 100. In the conversation device 100, when the conversation unit 101 receives speech information from the user terminal 200, the extraction unit 102 analyzes this speech information (S101).

The extraction unit 102 extracts topic information from a user's speech information (S102). Then, the conversation information generation unit 104 sets i=1 and manages the number of conversation information to be generated (S103). When i≤num (threshold) (S104: Yes), the conversation information generation unit 104 determines that the number of conversation information does not reach a predetermined number, and the search unit 103 searches for edge information and node information that derive from the topic information. When the search unit 103 finds a plurality of edge information and node information, it selects and acquires one edge information and one node information according to a specified rule (e.g., at random) (S105). Note that a plurality of edge information and a plurality of node information may be selected by presetting or the like.

Further, in Step S105, when generating conversation information of the second or subsequent sentence, the search unit 103 may acquire node information and edge information common to the conversation information generated previously. The details of this processing are described later.

Then, the conversation information generation unit 104 acquires the template corresponding to the edge information (S106). The conversation information generation unit 104 inserts the topic information and the acquired node information into this template, and thereby generates conversation information (S107).

When i≥2 (S108: Yes), the conversation information generation unit 104 couples the conversation information generated in S107 with the conversation information generated earlier (S109).

After that, to generate the next conversation information, the conversation information generation unit 104 changes the topic information. For example, the conversation information generation unit 104 changes the new topic information to the node information acquired in S105 (S110). Then, the conversation information generation unit 104 increments i by 1 (S111), and generates conversation information until reaching a predetermined number.

When the predetermined number is reached (S104: No), the conversation unit 101 outputs the conversation information generated in the conversation information generation unit 104 to the user terminal 200 (S112).

[Selection Variation of Node Information] A variation on processing of Step S105 in the conversation device 100 according to one embodiment of the present disclosure is described hereinafter. Although the search unit 103 retrieves randomly selected one edge information and one node information when searching for the edge information and the node information that derive from the topic information as described above, it is not limited thereto.

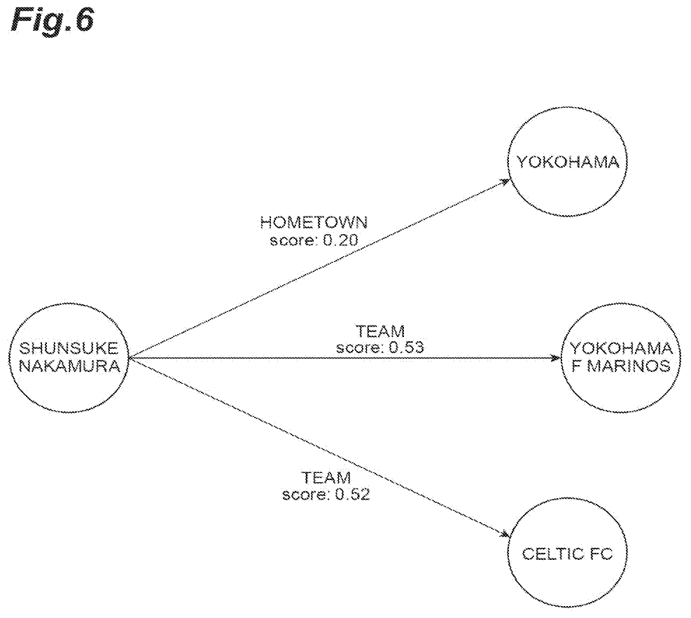

For example, the search unit 103 may select the node information with the highest similarity score between node information or the node information with a similarity score that is equal to or higher than a specified value from a plurality of edge information that derive from the topic information. FIG. 6 is a schematic view of the graph database 105 in which the edge information contains a similarity score. As shown therein, in the graph database 105, the node information are connected using the edge information, and the similarity score between the node information is contained in the edge information. Since the node information is a word, the similarity score between words is contained in the edge information. This similarity score is calculated by a known natural language analysis algorithm such as word2vec and added to the edge information when building the graph database 105. In FIG. 6, the similarity score between the node information: Shunsuke Nakamura and the node information: Yokohama F Marinos is 0.53. On the other hand, the similarity score between the node information: Shunsuke Nakamura and the node information: Yokohama is 0.20, and the similarity score between the node information: Shunsuke Nakamura and the node information: Celtic FC is 0.52. In this case, the search unit 103 selects the edge information: team and the node information: Yokohama F Marinos.

In the case of employing this selection processing using the similarity score, the following conversation information is generated. “Shunsuke Nakamura belonged to Yokohama F Marinos.”

As another variation, the search unit 103 may select one edge information and one node information corresponding to the category of the topic information. For example, the topic information: Shunsuke Nakamura structurally derives with respect to the node information: person as the edge information: category. This indicates that the category of the topic information: Shunsuke Nakamura is “person”.

Thus, when the topic information structurally derives with respect to the node information: person as the edge information: category, the search unit 103 may select the node information that is derived by predetermined edge information such as “hometown” and “birthday” among the plurality of retrieved edge information and node information. The above example is illustrative only, and it is not limited to the node information: person as the edge information: category. When, in the graph database 105, predetermined node information exists structurally for predetermined edge information, the search unit 103 may select this predetermined node information.

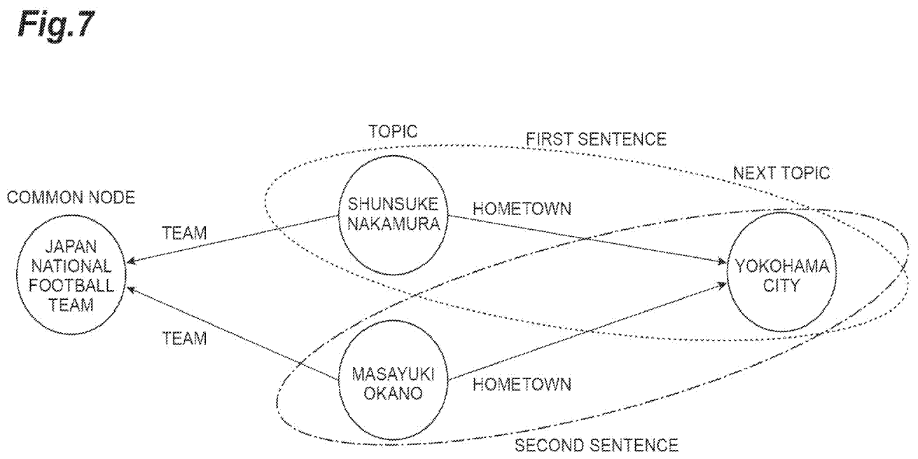

In the case of employing this processing of selecting the node information: Yokohama corresponding to the specified edge information: hometown, the following conversation information is generated. “Shunsuke Nakamura is from Yokohama.”

[Generation of Conversation Information Using Common Node Information] Processing when generating conversation information of the second or subsequent sentence is described hereinafter. When generating conversation information of the second or subsequent sentence, the search unit 103 may acquire the node information and the edge information common to the topic information extracted from speech information uttered first by a user. This is described hereinafter with reference to FIG. 7.

FIG. 7 is a schematic diagram showing the outline of processing for selecting common node information. In the example of FIG. 7, the search unit 103 acquires the edge information: hometown and the node information: Yokohama city by using the node information: Shunsuke Nakamura, which is the topic information, as a key, and the conversation information generation unit 104 generates the conversation information of the first sentence “Shun suke Nakamura is from Yokohama city”.

Next, in order for the conversation information generation unit 104 to generate conversation information of the second or subsequent sentence, the search unit 103 searches for other node information by using the node information: Yokohama city as a key. To be specific, the search unit 103 first searches for a plurality of other information that derive with respect to the node information. In this example, it searches for node information that derive in the opposite direction by edge information. Among them, it selects other node information associated with the common node information common to the node information: Shunsuke Nakamura, which is the topic information. In the example of FIG. 7, the node information: Masayuki Okano associated with the common node information: Japan national football team and the edge information: hometown are selected as other node information and other edge information.

The conversation information generation unit 104 selects a template from the template database by using other node information: Masayuki Okano, other edge information: hometown, common node information: Japan national football team, and its edge information team.

In the template database 106, a template for the case of using common node information is prepared, and a template associated with the first edge information (e.g., hometown), its time information, the second edge information (e.g., team), and its time information is prepared.

For example, as a template corresponding to the first edge information: hometown and the second edge information team, “[other node information] in the same [common node information] as [node information of topic information] is also from [node information]” is prepared. Although description of time information is omitted for the sake of illustration, a template in consideration of time information (present or past) is also prepared.

The conversation information generation unit 104 can generate conversation information by inserting topic information, common node information, other node information, and node information.

This processing allows generating natural conversation information with relevance in conversation.

Note that, in order to simplify the database of the template database 106, the following processing is also feasible.

It takes time and effort to prepare a template for the second sentence or a dedicated template for common node information. Therefore, “[other node information] is also from [node information]” is prepared as a normal template, and the conversation information generation unit 104 can generate conversation information by inserting other node information and other edge information into this template.

In this case, the conversation information generation unit 104 may further extract the template “[other node information] is in the same [common node information] as [node information of topic information]” as the third sentence and generate conversation information. Since the topic information and the common node information are already acquired by the search unit 103, the second sentence and the third sentence can be generated at the same timing.

The above-described variations may be used in combination. For example, when there is no node information having common node information, node information may be selected by using the similarity score between words. Further, in the case of selecting node information by using the similarity score between words, when there is no node information whose similarity score is equal to or higher than a predetermined value, node information may be selected randomly. Note that when there is no node information whose similarity score is equal to or higher than a predetermined value, node information having a common node may be searched and selected.

[Supplemental Sentence Generation Process] A second embodiment of the present disclosure is described hereinafter. This embodiment has a feature that, when node information to be inserted into conversation information is a word that is generally unknown (i.e., rare word), a supplemental sentence that supplements this word is generated.

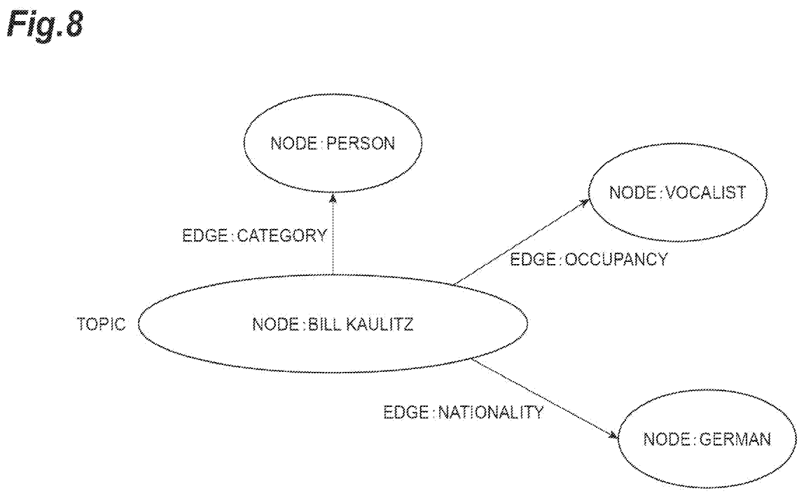

Conditions assumed in this embodiment are described with reference to FIG. 8. FIG. 8 is a schematic view showing a part of the graph database 105. The node information: Shinji Kagawa derives from the node information: Bill Kaulitz by the edge information: fan. It is assumed that Bill Kaulitz is a person who is less well-known in Japan, and stored as a less well-known person in the graph database 105.

In the case of having the above-described graph database, assume that the conversation device 100 outputs “Bill Kaulitz is a fan of Shinji Kagawa” as the conversation information to be provided to a user. Since Bill Kaulitz is a person who is less well-known in Japan as described above, the user cannot understand it in some cases.

Therefore, it is necessary to generate a supplemental sentence that supplements Bill Kaulitz. This processing is described hereinafter.

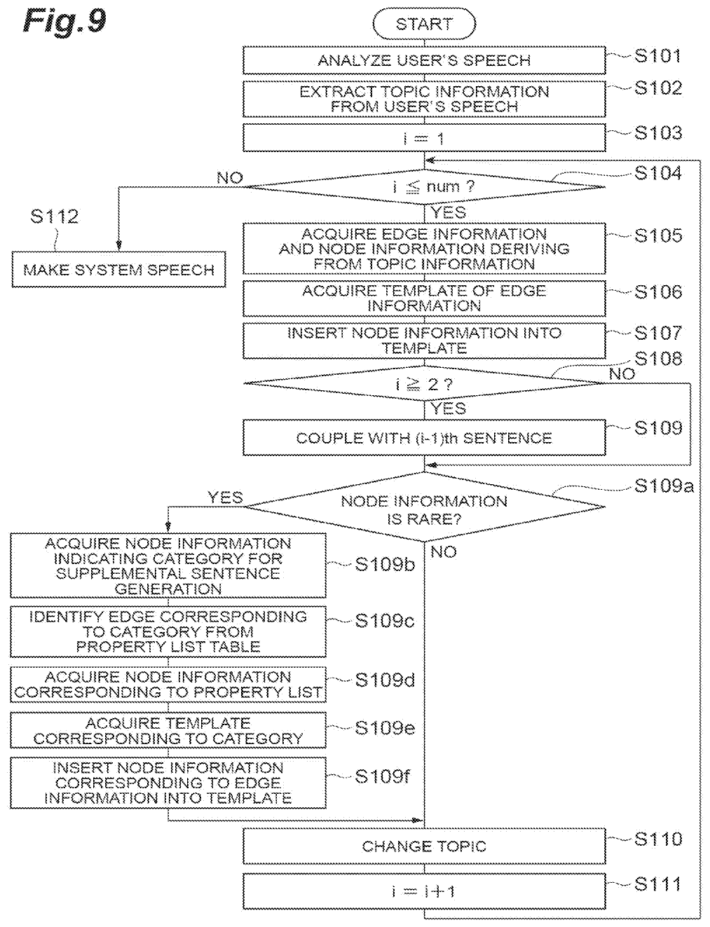

FIG. 9 is a flowchart showing the operation of the conversation device 100 capable of generating a supplemental sentence.

Steps S101 to S109 are the same as the processing shown in FIG. 5. After conversation information of the first sentence based on topic information is generated, the search unit 103 determines whether the node information extracted on the basis of this topic information is rare information (S109a). As criteria to determine whether the node information is rare information, the search unit 103 makes a determination on the basis of the number of edge information heading to the node information in the graph database 105. When the number of edge information heading to the node information is small, such as less than 30, for example, it can be determined that this node information is not referred to by other node information. In other words, it can be determined that this node information is information that is not generally known.

Note that the search unit 103 does not determine that the node information extracted from speech content uttered by a user is rare information even when it can be determined as rare information. For example, the conversation device 100 may include a history information storage unit that stores, as history information, node information obtained from the speech information of a user extracted by the extraction unit 102, and the search unit 103 may refrain from determining the node information stored as the history information as rare information even when the above-described condition is satisfied.

When the search unit 103 determines that the node information is rare information, it searches for node information for supplementation that supplements this node information and edge information. For example, in order to identify node information for supplementation that supplements the node information on the basis of the category of the node information, the search unit 103 selects one or a plurality of node information by using a property list table. The search unit 103 identifies the node information based on the selected edge information: occupation, nationality. This node information serves as node information for supplementation that supplements the node information extracted on the basis of the topic information.

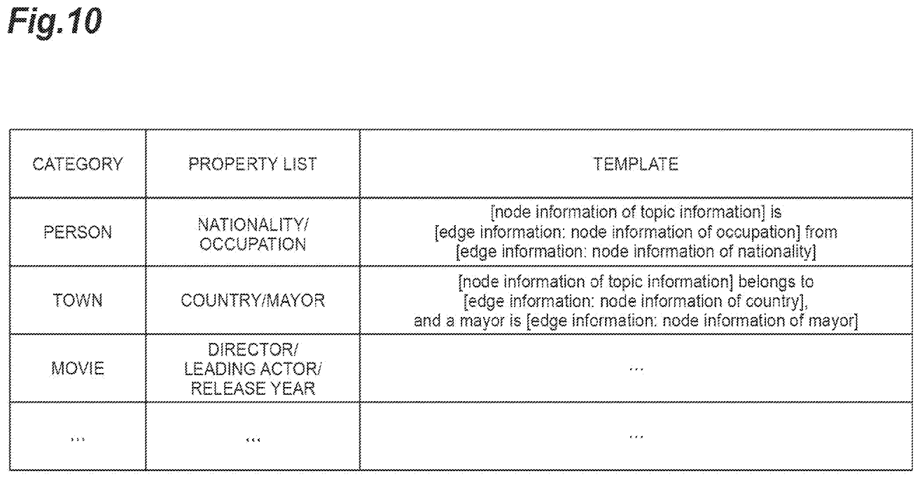

The detailed description is as follows. FIG. 10 shows a specific example of the property list table. This property list table (not shown) is included in the conversation device 100. As shown in the figure, this property list table stores a category, a property list, and a template in association with one another. The category is information indicated by the edge information, and the node information identified by the edge information: category is described in this category field. The property list shows the edge information for identifying the node information for supplementation that supplements the node information. The edge information identified by this property list and its node information are information for supplementing the node information that is rare.

For example, in FIG. 10, the property list “nationality” and “occupation”, and the template are associated with the category “person”. The template in this case is “[node information determined to be rare] is [node information indicating occupation] from [node information indicating nationality]”.

Using this property list table, the conversation information generation unit 104 first acquires the node information that derives from the node information determined to be rare by the edge information: category (S109b). As shown in FIG. 8, the information that derives from the node information: Bill Kaulitz by the edge information: category is the node information: person. This makes it known that Bill Kaulitz is a person.

Further, the conversation information generation unit 104 references the property list table and identifies the edge information for identifying the node information for supplementation on the basis of the edge information: category of the node information (S109c). In the example of FIG. 10, the property list in the case where the category of the node information is a person is the edge information: nationality/occupation.

Then, the conversation information generation unit 104 acquires the node information that derives from the rare node information by the edge information identified in S109c (S109d). As shown in FIG. 10, the node information for supplementation that derives from the rare node information: Bill Kaulitz by the edge information: nationality and occupation is the node information for supplementation: Germany and vocalist, respectively. Thus, the conversation information generation unit 104 can generate the supplemental sentence indicating that Bill Kaulitz is from Germany and is a vocalist.

The conversation information generation unit 104 references the property list table and acquires a template corresponding to the category of the node information obtained from the topic information (S109e). In the example of FIG. 10, since the category of the node information obtained from the topic information is “person”, it acquires the template corresponding to “person”. Then, the conversation information generation unit 104 inserts the node information for supplementation to the acquired template, and thereby generates the conversation information to serve as a supplemental sentence (S109f). In the example of FIG. 10, the template is “[node information determined to be rare] is [edge information: node information of occupation] from [edge information: node information of nationality]”, and therefore the conversation information to serve as a supplemental sentence is generated by inserting each of the node information.

The operations and effects of the conversation device 100 according to this embodiment are described hereinafter. The conversation device 100 according to this embodiment includes the graph database 105 that structurally stores the node information, which is a plurality of registered words, by using the edge information, which is relationship information indicating a mutual relationship.

Note that, although the graph database 105 stores the node information associated by directional edge information in this embodiment, the directionality is not essential. However, imparting the directionality helps accurately grasp the relationship between node information.

Then, the extraction unit 102 analyzes a user's speech content received by the conversation unit 101, and extracts the topic information, which is a primary word, from the speech content. In the above-described embodiment, the extraction unit 102 extracts the node information: Shunsuke Nakamura.

The search unit 103 searches the graph database 105 by using the node information being the topic information as a key, and thereby acquires corresponding node information (response information) and edge information (response relationship information). In the above-described embodiment, the search unit 103 acquires the edge information: team and the node information: Yokohama F Marinos.

The conversation information generation unit 104 generates conversation information, which is response content, by using the acquired node information and edge information. The conversation unit 101 outputs the generated conversation information to the user terminal 200.

This configuration allows the generation of conversation information by using the graph database that stores node information associated by edge information. This enables automatically generating high quality conversation information. Further, the cost of generation is reduced because of using the graph database 105. The reduction of generation cost contributes to reduction of the processing load of a processor such as a CPU in the conversation device 100 and simplification of a processing algorithm for conversation generation.

Further, in the conversation device 100, the conversation information generation unit 104 acquires a template corresponding to the acquired edge information, and inserts the node information into this template to generate conversation information, and the conversation unit 101 outputs the conversation information.

This configuration allows the generation of conversation information on the basis of a template corresponding to edge information. This enables natural conversation. For example, conversation information that makes a natural conversation is generated by acquiring a template corresponding to the edge information: team.

Further, in the conversation device 100, the graph database 105 stores ongoing information indicating, by start time and end time, whether the state of the node information associated by the edge information is ongoing or not. The conversation information generation unit 104 generates conversation information on the basis of the ongoing information indicated by start time and end time.

This configuration allows the generation of conversation information depending on whether the associated node information is in the past state or the ongoing state. This enables natural conversation. Note that the ongoing state is not necessarily indicated by start time and end time, and information indicating “ongoing” may be simply accompany the edge information.

Further, in the conversation device 100, the graph database 105 stores a plurality of other node information associated by edge information with node information that coincides with topic information. In this case, the search unit 103 may randomly select one node information from the plurality of other node information and use this information as a response word to be inserted into a template and response relationship information for selecting a template.

This configuration allows narrowing down node information to one and thereby generating natural conversation information. Note that node information is not limited to one, and two or more node information may be used.

Further, in the conversation device 100, the graph database 105 further stores a similarity score between node information. When, in the graph database 105, a plurality of other node information are stored in association with node information that coincides with topic information, the search unit 103 may select one node information on the basis of the similarity score and acquire this information as a response word to be inserted into a template and response relationship information for selecting a template.

This configuration allows selecting node information similar to topic information and thereby generating conversation information that is related to a user's speech.

Further, in the conversation device 100, the graph database 105 stores a plurality of other node information associated with node information that coincides with topic information.

The search unit 103 selects node information (Yokohama as hometown, date of birth) associated by other edge information (e.g., hometown, birthday) on the basis of node information (e.g., person) with edge information indicating a specified relationship (e.g., category) among other node information associated by edge information with node information that coincides with topic information.

When the category of topic information is “person”, there is a case where conversation information containing the birthday and hometown of this “person” is natural in terms of conversation. In this embodiment, the search unit 103 selects node information corresponding to the category of topic information, which enables natural conversation that is related to each other. Note that, although “category” is used as an example of edge information indicating a specified relationship in topic information in this embodiment, it is not limited thereto. Any edge information may be used as long as it is closely related to topic information.

Further, in the conversation device 100 according to this embodiment, the search unit 103 determines the degree of familiarity of node information extracted on the basis of topic information. In other words, it determines whether supplemental information is needed or not. When the degree of familiarity satisfies specified conditions, the search unit 103 acquires information as a supplemental response word (node information for supplementation: vocalist) to be inserted into a template for supplementation and supplemental response relationship information (edge information for supplementation: occupancy) for selecting a template for supplementation on the basis of the node information (person) with the edge information (category) indicating a specified relationship of the node information (rare word: Bill Kaulitz) extracted on the basis of the topic information. The conversation information generation unit 104 generates conversation information for supplementation using the node information for supplementation and the edge information for supplementation, in addition to conversation information.

This configuration generates conversation information for supplementation for node information with a small degree of familiarity, which is a rare word, and thereby prevents making a conversation that is difficult to be understood by a user.

For example, the search unit 103 can determine whether it is a rare word on the basis of its deriving direction in the graph database 105. Specifically, when certain node information is associated with many other node information by edge information, this node information can be determined to be referred to from many node information, and therefore it can be determined as a generally known word. On the contrary, when the number of such information is small (less than a specified value), it can be determined as a rare word that is not generally known. Note that, although “category” is used as an example of edge information indicating a specified relationship in this embodiment, it is not limited thereto. Any edge information may be used as long as it is closely related for supplementing node information.

Further, in the conversation device 100, after first response content using node information (Yokohama city in FIG. 7) acquired for topic information is generated, the search unit 103 acquires other node information (Masayuki Okano in FIG. 7) associated with this acquired node information (Yokohama city in FIG. 7) as a response word to be inserted into a template. The other node information (Masayuki Okano in FIG. 7) acquired as a response word and the node information that coincides with topic information (Shunsuke Nakamura in FIG. 7) have node information (Japan national football team in FIG. 7) associated using edge information (team in FIG. 7) in common. Thus, the search unit 103 acquires, as a response word, other node information associated with common node information that is common to node information of topic information.

The conversation information generation unit 104 generates second response content containing other node information (response word) in addition to the first response content.

This configuration allows extending conversation in a natural manner.

The block diagram used for the description of the above embodiments shows blocks of functions. Those functional blocks (component parts) are implemented by any combination of at least one of hardware and software. Further, a means of implementing each functional block is not particularly limited. Specifically, each functional block may be implemented by one physically or logically combined device or may be implemented by two or more physically or logically separated devices that are directly or indirectly connected (e.g., by using wired or wireless connection etc.). The functional blocks may be implemented by combining software with the above-described one device or the above-described plurality of devices.

The functions include determining, deciding, judging, calculating, computing, processing, deriving, investigating, looking up/searching/inquiring, ascertaining, receiving, transmitting, outputting, accessing, resolving, selecting, choosing, establishing, comparing, assuming, expecting, considering, broadcasting, notifying, communicating, forwarding, configuring, reconfiguring, allocating/mapping, assigning and the like, though not limited thereto. For example, the functional block (component part) that implements the function of transmitting is referred to as a transmitting unit or a transmitter. In any case, a means of implementation is not particularly limited as described above.

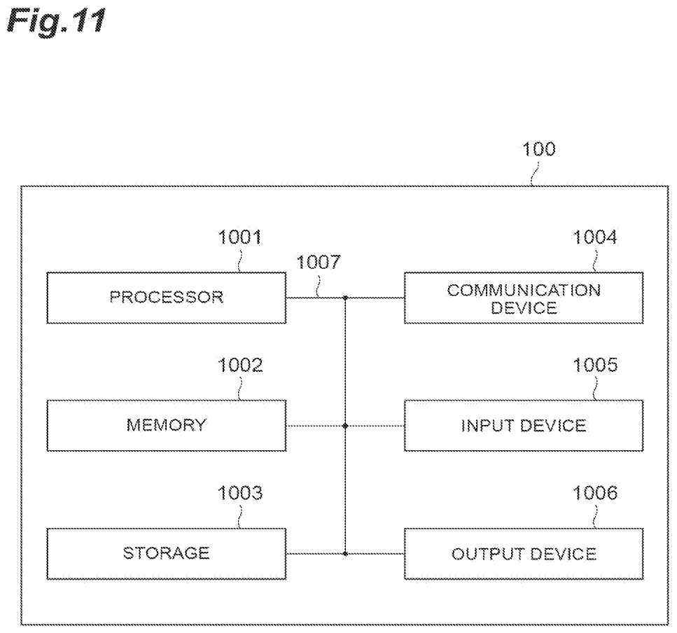

For example, the conversation device 100 and the like according to one embodiment of the present disclosure may function as a computer that performs processing of a conversation method or a conversation information generation method according to the present disclosure. FIG. 11 is a view showing an example of the hardware configuration of the conversation device 100 according to one embodiment of the present disclosure. The conversation device 100 described above may be physically configured as a computer device that includes a processor 1001, a memory 1002, a storage 1003, a communication device 1004, an input device 1005, an output device 1006, a bus 1007 and the like.

In the following description, the term “device” may be replaced with a circuit, a device, a unit, or the like. The hardware configuration of the conversation device 100 may be configured to include one or a plurality of the devices shown in the drawings or may be configured without including some of those devices.

The functions of the conversation device 100 may be implemented by loading predetermined software (programs) on hardware such as the processor 1001 and the memory 1002, so that the processor 1001 performs computations to control communications by the communication device 1004 and control at least one of reading and writing of data in the memory 1002 and the storage 1003.

The processor 1001 may, for example, operate an operating system to control the entire computer. The processor 1001 may be configured to include a CPU (Central Processing Unit) including an interface with a peripheral device, a control device, an arithmetic device, a register and the like. For example, the extraction unit 102, the search unit 103, the conversation information generation unit 104 and the like described above may be implemented by the processor 1001.

Further, the processor 1001 loads a program (program code), a software module and data from at least one of the storage 1003 and the communication device 1004 into the memory 1002 and performs various processing according to them. As the program, a program that causes a computer to execute at least some of the operations described in the above embodiments is used. For example, the extraction unit 102, the search unit 103, and the conversation information generation unit 104 of the conversation device 100 may be implemented by a control program that is stored in the memory 1002 and operates on the processor 1001, and the other functional blocks may be implemented in the same way. Although the above-described processing is executed by one processor 1001 in the above description, the processing may be executed simultaneously or sequentially by two or more processors 1001. The processor 1001 may be implemented in one or more chips. Note that the program may be transmitted from a network through a telecommunications line.

The memory 1002 is a computer-readable recording medium, and it may be composed of at least one of ROM (Read Only Memory), EPROM (ErasableProgrammable ROM), EEPROM (Electrically ErasableProgrammable ROM), RANI (Random Access Memory) and the like, for example. The memory 1002 may be also called a register, a cache, a main memory (main storage device) or the like. The memory 1002 can store a program (program code), a software module and the like that can be executed for implementing a conversation method according to one embodiment of the present disclosure.

The storage 1003 is a computer-readable recording medium, and it may be composed of at least one of an optical disk such as a CD-ROM (Compact Disk ROM), a hard disk drive, a flexible disk, a magneto-optical disk (e.g., a compact disk, a digital versatile disk, and a Blu-ray (registered trademark) disk), a smart card, a flash memory (e.g., a card, a stick, and a key drive), a floppy (registered trademark) disk, a magnetic strip and the like, for example. The storage 1003 may be called an auxiliary storage device. The above-described storage medium may be a database, a server, or another appropriate medium including the memory 1002 and/or the storage 1003, for example.

The communication device 1004 is hardware (a transmitting and receiving device) for performing communication between computers via at least one of a wired network and a wireless network, and it may also be referred to as a network device, a network controller, a network card, a communication module, or the like. The communication device 1004 may include a high-frequency switch, a duplexer, a filter, a frequency synthesizer or the like in order to implement at least one of FDD (Frequency Division Duplex) and TDD (Time Division Duplex), for example. For example, the above-described conversation unit 101 or the like may be implemented by the communication device 1004. The conversation unit 101 may be implemented in such a way that a transmitting unit and a receiving unit are physically or logically separated.

The input device 1005 is an input device (e.g., a keyboard, a mouse, a microphone, a switch, a button, a sensor, etc.) that receives an input from the outside. The output device 1006 is an output device (e.g., a display, a speaker, an LED lamp, etc.) that makes output to the outside. Note that the input device 1005 and the output device 1006 may be integrated (e.g., a touch panel).

In addition, the devices such as the processor 1001 and the memory 1002 are connected by the bus 1007 for communicating information. The bus 1007 may be a single bus or may be composed of different buses between different devices.

Further, the conversation device 100 may include hardware such as a microprocessor, a DSP (Digital Signal Processor), an ASIC (Application Specific Integrated Circuit), a PLD (Programmable Logic Device), and an FPGA (Field Programmable Gate Array), and some or all of the functional blocks may be implemented by the above-described hardware components. For example, the processor 1001 may be implemented with at least one of these hardware components.

Notification of information may be made by another method, not limited to the aspects/embodiments described in the present disclosure. For example, notification of information may be made by physical layer signaling (e.g., DCI (Downlink Control Information), UCI (Uplink Control Information)), upper layer signaling (e.g., RRC (Radio Resource Control) signaling, MAC (Medium Access Control) signaling, annunciation information (MIB (Master Information Block), SIB (System Information Block))), another signal, or a combination of them. Further, RRC signaling may be called an RRC message, and it may be an RRC Connection Setup mess age, an RRC Connection Reconfiguration message or the like, for example.

Further, each of the aspects/embodiments described in the present disclosure may be applied to at least one of a system using LTE (Long Term Evolution), LTE-A (LTE Advanced), SUPER 3G, IMT-Advanced, 4G (4th generation mobile communication system), 5G (5th generation mobile communication system), FRA (Future Radio Access), NR (new Radio), W-CDMA (registered trademark), GSM (registered trademark), CDMA2000, UMB (Ultra Mobile Broadband), IEEE 802.11 (Wi-Fi), IEEE 802.16 (WiMAX), IEEE 802.20, UWB (Ultra Wide Band), Bluetooth (registered trademark), or another appropriate system and a next generation system extended on the basis of these systems. Further, a plurality of systems may be combined (e.g., a combination of at least one of LTE and LTE-A, and 5G) for application.

The procedure, the sequence, the flowchart and the like in each of the aspects/embodiments described in the present disclosure may be in a different order unless inconsistency arises. For example, for the method described in the present disclosure, elements of various steps are described in an exemplified order, and it is not limited to the specific order described above.

The information or the like can be output from an upper layer (or lower layer) to a lower layer (or upper layer). It may be input and output through a plurality of network nodes.

Input/output information or the like may be stored in a specific location (e.g., memory) or managed in a management table. Further, input/output information or the like can be overwritten or updated, or additional data can be written. Output information or the like may be deleted. Input information or the like may be transmitted to another device.

The determination may be made by a value represented by one bit (0 or 1), by a truth-value (Boolean: true or false), or by numerical comparison (e.g., comparison with a specified value).

Each of the aspects/embodiments described in the present disclosure may be used alone, may be used in combination, or may be used by being switched according to the execution. Further, a notification of specified information (e.g., a notification of “being X”) is not limited to be made explicitly, and it may be made implicitly (e.g., a notification of the specified information is not made).

Although the present disclosure is described in detail above, it is apparent to those skilled in the art that the present disclosure is not restricted to the embodiments described in this disclosure. The present disclosure can be implemented as a modified and changed form without deviating from the spirit and scope of the present disclosure defined by the appended claims. Accordingly, the description of the present disclosure is given merely by way of illustration and does not have any restrictive meaning to the present disclosure.

Software may be called any of software, firmware, middle ware, microcode, hardware description language or another name, and it should be interpreted widely so as to mean an instruction, an instruction set, a code, a code segment, a program code, a pro gram, a sub-program, a software module, an application, a software application, a software package, a routine, a sub-routine, an object, an executable file, a thread of execution, a procedure, a function and the like.

Further, software, instructions and the like may be transmitted and received via a transmission medium. For example, when software is transmitted from a website, a server or another remote source using at least one of wired technology (a coaxial cable, an optical fiber cable, a twisted pair and a digital subscriber line (DSL) etc.) and wireless technology (infrared rays, microwave etc.), at least one of those wired technology and wireless technology are included in the definition of the transmission medium.

The information, signals and the like described in the present disclosure may be represented by any of various different technologies. For example, data, an instruction, a command, information, a signal, a bit, a symbol, a chip and the like that can be referred to in the above description may be represented by a voltage, a current, an electromagnetic wave, a magnetic field or a magnetic particle, an optical field or a photon, or an arbitrary combination of them.

Note that the term described in the present disclosure and the term needed to understand the present disclosure may be replaced by a term having the same or similar meaning. For example, at least one of a channel and a symbol may be a signal (signaling). Further, a signal may be a message. Furthermore, a component carrier (CC) may be called a cell, a frequency carrier, or the like.

The terms “system” and “network” used in the present disclosure are used to be compatible with each other.

Further, information, parameters and the like described in the present disclosure may be represented by an absolute value, a relative value to a specified value, or corresponding different information. For example, radio resources may be indicated by an index.

The names used for the above-described parameters are not definitive in any way. Further, mathematical expressions and the like using those parameters are different from those explicitly disclosed in the present disclosure in some cases. Because various channels (e.g., PUCCH, PDCCH etc.) and information elements (e.g., TPC etc.) can be identified by every appropriate names, various names assigned to such various channels and information elements are not definitive in any way.

In the present disclosure, the terms such as “Mobile Station (MS)” “user terminal”, “User Equipment (UE)” and “terminal” can be used to be compatible with each other.

The mobile station can be also called, by those skilled in the art, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client or several other appropriate terms.

Note that the term “determining” and “determining” used in the present disclosure includes a variety of operations. For example, “determining” and “determining” can include regarding the act of judging, calculating, computing, processing, deriving, investigating, looking up/searching/inquiring (e.g., looking up in a table, a database or another data structure), ascertaining or the like as being “determined” and “determined”. Further, “determining” and “determining” can include regarding the act of receiving (e.g., receiving information), transmitting (e.g., transmitting information), inputting, outputting, accessing (e.g., accessing data in a memory) or the like as being “determined” and “determined”. Further, “determining” and “determining” can include regarding the act of resolving, selecting, choosing, establishing, comparing or the like as being “determined” and “determined”. In other words, “determining” and “determining” can include regarding a certain operation as being “determined” and “determined”. Further, “determining (determining)” may be replaced with “assuming”, “expecting”, “considering” and the like.

The term “connected”, “coupled” or every transformation of this term means every direct or indirect connection or coupling between two or more elements, and it includes the case where there are one or more intermediate elements between two elements that are “connected” or “coupled” to each other. The coupling or connection between elements may be physical, logical, or a combination of them. For example, “connect” may be replaced with “access”. When used in the present disclosure, it is considered that two elements are “connected” or “coupled” to each other by using at least one of one or more electric wires, cables, and printed electric connections and, as several non-definitive and non-comprehensive examples, by using electromagnetic energy such as electromagnetic energy having a wavelength of a radio frequency region, a microwave region and an optical (both visible and invisible) region.

The description “on the basis of” used in the present disclosure does not mean “only on the basis of” unless otherwise noted. In other words, the description “on the basis of” means both of “only on the basis of” and “at least on the basis of”.

When the terms such as “first” and “second” are used in the present disclosure, any reference to the element does not limit the amount or order of the elements in general. Those terms can be used in the present disclosure as a convenient way to distinguish between two or more elements. Thus, reference to the first and second elements does not mean that only two elements can be adopted or the first element needs to precede the second element in a certain form.

Furthermore, “means” in the configuration of each device described above may be replaced by “unit”, “circuit”, “device” or the like.

As long as “include”, “including” and transformation of the in are used in the present disclosure, those terms are intended to be comprehensive like the term “comprising”. Further, the term “or” used in the present disclosure is intended not to be exclusive OR.

In the present disclosure, when articles, such as “a”, “an”, and “the” in English, for example, are added by translation, the present disclosure may include that nouns following such articles are plural.

In the present disclosure, the term “A and B are different” may mean that “A and B are different from each other”. Note that this term may mean that “A and B are different from C”. The terms such as “separated” and “coupled” may be also interpreted in the same manner.

### REFERENCE SIGNS LIST

100 . . . conversation device, 200 . . . user terminal, 101 . . . conversation unit, 102 . . . extraction unit, 103 . . . search unit, 104 . . . conversation information generation unit, 105 . . . graph database, 106 . . . template database

1. A conversation device comprising:
a storage unit configured to structurally store a plurality of registered words by using relationship information indicating a mutual relationship;
an analysis unit configured to analyze speech content of a user;
an extraction unit configured to extract a primary word from the speech content;
a search unit configured to search the storage unit by using the primary word as a key, and acquire a corresponding registered word and relationship information as a response word and response relationship information; and
a response unit configured to generate and output response content by using the response word and the response relationship information.

2. The conversation device according to claim 1, further comprising:
a template database associating a template for generating response content with response relationship information, wherein
the response unit acquires a template corresponding to the acquired response relationship information, and generates and outputs response content where the response word is inserted into the template.

3. The conversation device according to claim 1, wherein
the storage unit stores ongoing information indicating whether a state indicated by a registered word associated using the relationship information is ongoing, and
the response unit generates response content on the basis of the ongoing information.

4. The conversation device according to claim 1,
wherein, when a plurality of other registered words are stored in association with a registered word coinciding with the primary word by using relationship information in the storage unit, the search unit randomly selects and acquires a registered word as a response word and response relationship information from the plurality of other registered words.

5. The conversation device according to claim 1, wherein
the storage unit further stores a similarity score between the registered words, and
when a plurality of other registered words are stored for a registered word coinciding with the primary word in the storage unit, the search unit selects and acquires a registered word as a response word and response relationship information on the basis of the similarity score.

6. The conversation device according to claim 1, wherein, when a plurality of other registered words are stored for a registered word coinciding with the primary word in the storage unit, the search unit selects and acquires, as a response word and response relationship information, a registered word associated using other relationship information on the basis of a registered word with relationship information indicating a specified relationship among other registered words associated from a registered word coinciding with the primary word by using relationship information.

7. The conversation device according to claim 1, wherein
the search unit determines whether supplemental information is needed for a registered word acquired as a response word on the basis of the primary word,
when supplemental information is needed, the search unit acquires as a supplemental response word and supplemental response relationship information on the basis of a registered word with relationship information indicating a specified relationship of a registered word extracted as the response word, and
the response unit further generates supplemental response content using the supplemental response word and the supplemental response relationship information, in addition to the response content.

8. The conversation device according to claim 7, wherein
the storage unit associates the registered words by imparting directionality to the relationship information, and
the search unit determines whether supplemental information is needed by determining whether association is made to a registered word extracted as the response word from other registered words being less than a specified number by using the relationship information.

9. The conversation device according to claim 1, wherein
after first response content using a registered word acquired for a primary word is generated, the search unit acquires another registered word associated with the registered word as a response word,
the response word is associated in common to a registered word associated with a registered word coinciding with the primary word by using relationship information, and
the response unit generates second response content containing another registered word, in addition to the first response content.

10. The conversation device according to claim 2, wherein
the storage unit stores ongoing information indicating whether a state indicated by a registered word associated using the relationship information is ongoing, and
the response unit generates response content on the basis of the ongoing information.
